(19) United States
(12) Patent Application Publication
(10) Pub. No.: US 2010/0055012 A1
(43) Pub. Date: Mar. 4, 2010

(54) NITROGEN OXIDE STORAGE CATALYST FEATURING A REDUCED DESULFURIZATION TEMPERATURE

(76) Inventors: Ina Grisstede, Hanau (DE); Friedemann Rohr, Hanau (DE); Stephan Eckhoff, Alzenau (DE); Wilfried Mueller, Karben (DE); Thomas Kreuzer, Karben (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/444,304

(22) PCT Filed: Aug. 30, 2007
(86) PCT No.: PCT/EP2007/059057

§ 371 Date: Oct. 20, 2009

(30) Foreign Application Priority Data
Oct. 6, 2006 (EP) 06020994.7

(51) Int. Cl. B01D 53/94; B01J 23/42; B01J 23/10; B01J 21/06; B01J 27/232

(52) U.S. Cl. 423/213.5; 502/339; 502/304; 502/303; 502/262; 502/174

(57) ABSTRACT

Nitrogen oxide storage catalysts are used to remove nitrogen oxides from the exhaust gas of internal combustion engines operated predominantly under lean burn conditions. When these catalysts are used in diesel vehicles, the increased sulfur content in the fuel during operation results in poisoning of the catalyst, which is reversible at high temperatures under reduced exhaust gas conditions. In the case of conventional nitrogen oxide storage catalysts, temperatures of more than 600° C. have to be obtained for desulfurization. This is not always possible in diesel vehicles with a nitrogen oxide storage catalyst in the underbody area.

The invention presents a process whose application allows the desulfurization temperature of conventional nitrogen oxide storage catalysts which comprise a platinum component and at least one nitrogen oxide storage material to be lowered. The basicity of the chemical environment of the platinum is lowered, while the nitrogen oxide storage material can remain unchanged as such. In addition, an improved nitrogen oxide storage catalyst with reduced desulfurization temperature which results from the application of the process is presented. Such catalysts are suitable particularly for nitrogen oxide aftertreatment of the exhaust gases of diesel engines.

The invention relates to a process for preparing a nitrogen oxide storage catalyst with a reduced desulfurization temperature, and to a nitrogen oxide storage catalyst with a reduced desulfurization temperature.

Nitrogen oxide storage catalysts are used to remove the nitrogen oxides present in the exhaust gas of internal combustion engines operated predominantly under lean conditions. Their mode of operation is described in detail in SAE document SAE 950809. The cleaning action of the nitrogen oxide storage catalysts is based on the fact that, in a lean operating phase of the engine, the nitrogen oxides are stored by the storage material of the storage catalyst, predominantly in the form of nitrates, and the nitrates formed beforehand are decomposed in a subsequent rich operating phase of the engine, and the nitrogen oxides released again are reacted with the reducing exhaust gas constituents over the storage catalysts to give nitrogen, carbon dioxide and water. The internal combustion engines operated under predominantly lean conditions include, as well as the direct-injection gasoline engines with layered mixture formation in the cylinder, in particular also diesel engines.

Nitrogen oxide storage catalysts consist frequently of a catalyst material, which is usually applied in the form of a coating to an inert support body composed of ceramic or metal.

The catalyst material of the nitrogen oxide storage catalyst comprises at least one nitrogen oxide storage material and a catalytically active component. The nitrogen oxide storage material in turn consists of the actual nitrogen oxide storage component, which is deposited on a support material in highly dispersed form.

The storage components used are predominantly the basic oxides of the alkali metals, of the alkaline earth metals and of the rare earth metals, which react with nitrogen dioxide to give the corresponding nitrates. It is known that these materials are present under air predominantly in the form of carbonates and hydroxides. These compounds are likewise suitable for storing the nitrogen oxides. When reference is therefore made in the context of the invention to the basic storage oxides, this also includes the corresponding carbonates and hydroxides.

Suitable support materials for the storage components are thermally stable metal oxides with a high surface area of more than 10 m²/g, which enable highly dispersed deposition of the storage components. Suitable examples are cerium oxide and cerium-containing mixed oxides, aluminum oxide, magnesium oxide, magnesium-aluminum mixed oxides, rare earths and some ternary oxides.

The catalytically active components present in the catalyst material of the nitrogen oxide storage catalyst have the task of converting the carbon monoxide and hydrocarbon pollutant gases present in the lean exhaust gas to carbon dioxide and water. In addition, they serve to oxidize the nitrogen monoxide present in the exhaust gas to nitrogen dioxide, in order that it can react with the basic storage material to give nitrates. For this purpose, the noble metals of the platinum group, especially platinum, are usually used, which are generally deposited separately from the storage components on a separate support material. The support materials used for the platinum group metals in nitrogen oxide storage catalysts are frequently high-surface area oxides, which may have distinct basicity.

For example, EP 1 317 953 A1 to the applicant describes a nitrogen oxide storage catalyst which, as well as nitrogen oxide storage components, comprises an oxidation-active component, for example platinum, on a support material. The excellent properties of the nitrogen oxide storage catalyst described in this application with regard to the width of the temperature window, the storage efficiency and the aging stability are based essentially on the support material composed of a homogeneous Mg/Al mixed oxide used for the platinum, said support material containing magnesium oxide in a concentration of from 1 to 40% by weight, based on the total weight of the Mg/Al mixed oxide, and, in a further advantageous configuration, being additionally dopable with cerium oxide or praseodymium oxide. WO 2005/092481 to the applicant describes a further nitrogen oxide storage catalyst which differs from that described in EP 1 317 953 A1 by an improved nitrogen oxide storage material.

EP 1 016 448 B1 describes a catalyst for the cleaning of lean exhaust gases, which comprises a composite support oxide composed of alkaline earth metal oxide and aluminum oxide with a platinum structure layer applied thereto, the platinum clusters being dispersed homogeneously in a matrix composed of alkaline earth metal oxide.

EP 1 321 186 B1 describes a nitrogen oxide storage catalyst in which the catalytically active noble metal, for example platinum, can be applied to an oxidic support material or directly to the NOₓ adsorbent.

When such nitrogen oxide storage catalysts are used for exhaust gas aftertreatment in diesel vehicles, it should be noted that even the so-called low-sulfur diesel fuel with not more than 50 ppm still contains about five times as much residual sulfur as gasoline. This sulfur is usually present in organic sulfur compounds and is converted in the combustion chamber of the engine predominantly to sulfur dioxide SO₂, which then arrives at the nitrogen oxide storage catalyst with the exhaust gas. In analogy to the storage mechanism for nitrogen oxides, SO₂ is oxidized over the catalytically active component to SO₃, and is then intercalated into the nitrogen oxide storage material to form the corresponding sulfates. With increasing intercalation of the nitrogen oxides and sulfur oxides into the storage material, the storage capacity of the material decreases. The nitrates formed by the intercalation of nitrogen oxides can be decomposed to nitrogen oxides NOₓ as a result of the short-term enrichment of the exhaust gas, and reduced using carbon monoxide, hydrogen and hydrocarbons as reducing agents to nitrogen with formation of water and carbon dioxide. Since the sulfates formed by the intercalation of the sulfur oxides are more thermally stable than the corresponding nitrates, the storage of sulfur oxides under normal operating conditions leads to poisoning of the nitrogen oxide storage catalyst, which, even under reducing exhaust gas conditions, is generally reversible only at high temperatures, i.e. above 600° C. This is also true of so-called “sulfur-tolerant” nitrogen oxide storage catalysts, as described, for example, in EP 1 304 156 A1. For the desulfurization of such catalysts, generally exhaust gas temperatures of more than 600° C. and alternating reducing and slightly oxidizing exhaust gas conditions are established. Such a desulfurizing operation can take several minutes and is frequently possible only close to full-load operation of the engine.

US 2005/0164879 A1 describes a multilayer catalyst which comprises a coating which absorbs sulfur oxides upstream of or above a coating which absorbs nitrogen oxides and/or a three-way catalytic converter coating. The exhaust gas to be cleaned must, before it comes into contact with the coating which stores nitrogen oxides or the three-way catalytic converter coating, first pass through this coating which absorbs sulfur oxides. The sulfur oxides are selectively and reversibly absorbed by the coating which absorbs sulfur oxides from the exhaust gas and the sulfur poisoning of the downstream nitrogen oxide storage material is prevented or alleviated.

In diesel vehicles whose exhaust gas cleaning system, apart from a nitrogen oxide storage catalyst, also comprises a diesel oxidation catalyst close to the engine and a diesel particulate filter, it may be advantageous to arrange the diesel particulate filter immediately downstream of the diesel oxidation catalyst close to the engine, such that the nitrogen oxide storage catalyst has to be accommodated on the downstream side of the diesel particulate filter in the underbody area of the vehicle. This can, for example, facilitate the attainment of the soot ignition temperature during the diesel particulate filter regeneration. Since the enrichment for the NOₓ regeneration of the nitrogen oxide storage catalyst in the diesel vehicle is generally effected by injecting further fuel, such an arrangement has the advantage that exotherms, which can arise at the start of the NOₓ regeneration phases as a result of the oxidation of unburnt fuel, are prevented at the nitrogen oxide storage catalyst. However, it is impossible in such an arrangement to establish temperatures of more than 600° C., as required for desulfurization of conventional nitrogen oxide storage catalysts.

It is therefore an object of the present invention to provide a process with which the desulfurization temperature of a nitrogen oxide storage catalyst comprising a platinum component and at least one nitrogen oxide storage material, the platinum component consisting of platinum on a high-surface area, high-melting oxidic support material A, and the nitrogen oxide storage material comprising at least one nitrogen oxide storage component on one or more high-melting, oxidic support materials, can be lowered. This object is achieved by a process for producing a nitrogen oxide storage catalyst with reduced desulfurization temperature, proceeding from the formulation of a nitrogen oxide storage catalyst according to the prior art described. The process is characterized in that at least one third of the amount of platinum used is applied to a high-melting, high-surface area oxidic support material B, support material B being less basic than support material A. This lowers the basicity of the chemical environment of the platinum overall.

In a preferred embodiment of the process, half of the amount of the platinum used is applied to the less basic support material B.

The fact that the lowering of the basicity of the chemical environment of the platinum leads to improved desulfurization performance, even though no changes to the nitrogen oxide storage material are undertaken by this measure, is the surprising result of intensive optimization work by the applicant on the lowering of the desulfurization temperature of conventional nitrogen oxide storage catalysts. Without any claim of establishing scientifically founded teaching, it is suspected that the effect observed is based on the mechanism of action described hereinafter:

When sulfur dioxide SO₂ formed in the combustion chamber of the engine meets the surface of the nitrogen oxide storage catalyst, it is first oxidized over the platinum to SO₃ in a lean atmosphere. In order to be converted over a platinum reaction site, the acidic pollutant gas must first be adsorbed on a basic component and passed on to a Pt reaction site. The SO₂ can be adsorbed directly on the nitrogen oxide storage component or on the basic support oxide of the platinum. In any case, the basic support material assumes an anchoring role in the transport of the SO₂ molecule to the reactive site on the platinum. The oxidation of SO₂ to SO₃ then proceeds there. This SO₃ is in turn, without complete desorption from the adsorption site on the platinum, “passed on”, possibly via the basic platinum support oxide, to the nitrogen oxide storage component and stored thereby to form the corresponding sulfate.

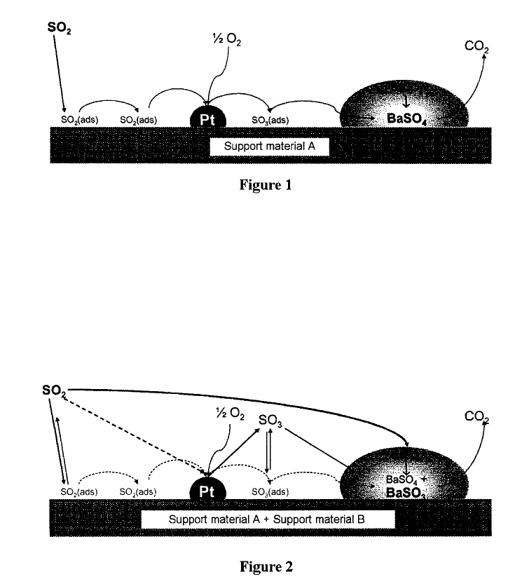

FIG. 1 shows, in schematic form, the intercalation step assumed, using the example of a nitrogen oxide storage catalyst with a barium-based nitrogen oxide storage component.

When a significant portion of the basic support material of the platinum is replaced by a less basic support material, this probably has the effect that, firstly, the adsorption rates of the SO₂ are reduced, and, secondly, the “passing-on” processes of the sulfur oxides both to the Pt reaction site and to the nitrogen oxide storage component are prevented by virtue of the “anchoring action” of the surface with respect to the sulfur oxides being reduced. As a result, no longer the entire SO₂ content in the exhaust gas is oxidized to SO₃ or “passed on”. The intercalation of the SO₂ remaining in the exhaust gas within the nitrogen oxide storage material leads to resulting sulfites, which can be reduced more easily to sulfides in the rich phase than sulfates. The sulfites and sulfides of the typical nitrogen oxide storage components are generally thermodynamically less stable than the sulfates resulting from the intercalation of SO₃ and can be decomposed again at moderate temperatures. As a result, the desulfurization temperature of the catalyst is reduced.

FIG. 2 shows, in schematic form, the intercalation step assumed, by way of example for the use of a barium-based nitrogen oxide storage component at reduced basicity of the chemical environment of the platinum. In this figure, the solid lines show the reaction paths of the sulfur oxides which probably occur predominantly.

The lowering of the basicity of the chemical environment of the platinum thus possibly reduces the SO₂ oxidation rates on the platinum and hinders the “passing-on” processes of the sulfur oxides on the surface of the catalyst, and thus leads, as described, to the lowering of the desulfurization temperature thereof.

The supporting of at least one third, preferably half, of the amount of platinum used on a second, less basic support material can under some circumstances have an influence on the nitrogen oxide storage efficiency. One of the advantageous configurations of the invention is therefore when the less basic support material B is used in deficiency compared to the more basic support material A, the amount of the less basic support material B required being guided by the target temperature to which the desulfurization temperature should be lowered. The ratio between support materials A:B is preferably in the range from 1.5:1 to 5:1.

According to the type of support material used to lower the basicity of the chemical environment of the platinum, this measure can result in a slight destabilization of the platinum dispersion and, as a result of this, slight losses in the nitrogen oxide storage efficiency, especially in the low-temperature range up to 350° C. However, the storage efficiency in the low-temperature range up to 350° C. is of particular significance for the applications described at the outset in diesel vehicles, and so this possibly has to be balanced by suitable measures.

In a preferred embodiment of the process, a cerium oxide, a cerium-zirconium mixed oxide or a cerium oxide doped with rare earths or combinations thereof is therefore added in a sufficient amount, i.e. at least 5% by weight, based on the total amount of the catalytically active components, to the new nitrogen oxide storage catalyst formulation which arises through lowering of the basicity of the chemical environment. Since cerium oxide firstly, especially within the temperature range between 150° C. and 300° C., possesses the ability to store nitrogen oxide, and due to the oxygen storage capacity intrinsic to the material can secondly intervene in a supporting manner in the process of NO oxidation to NO₂ within this temperature range, which is the prerequisite for effective nitrogen oxide storage, the addition of the cerium oxide component in a sufficient amount has the effect that the low-temperature storage efficiency is at least retained, possibly improved. The fact that cerium oxide can also intercalate sulfur oxides under lean conditions within the temperature range, in the applicant's experience, does not have an adverse effect on the desulfurization characteristics of the corresponding nitrogen oxide storage catalysts, since the resulting cerium(III) sulfate can be decomposed again even at moderate temperatures under reducing conditions in the rich phase.

The process described constitutes a technical teaching that can be applied to all nitrogen oxide storage catalysts which feature a platinum component consisting of platinum on a high-surface area, high-melting oxidic support material and at least one nitrogen oxide storage component on one or more high-melting oxidic support materials. Proceeding from a nitrogen oxide storage catalyst according to the prior art described, application of the process described in its preferred configurations results in an improved nitrogen oxide storage catalyst with a reduced desulfurization temperature, characterized in that half of the platinum has been applied to a strongly basic support material and the other half to a less basic support material. In addition, this improved nitrogen oxide storage catalyst contains at least 5% by weight of cerium oxide or cerium-zirconium mixed oxide or cerium oxide doped with rare earths or combinations thereof, based on the total amount of the catalytically active components.

Proceeding from the catalyst formulation described in EP 1 317 953 A1 to the applicant, a particularly preferred variant of the nitrogen oxide storage catalyst is obtained, in which half of the platinum has been applied to a homogeneous Mg/Al mixed oxide, the magnesium oxide being present in a concentration of from 5 to 28% by weight, especially from 10 to 25% by weight, based on the total weight of the Mg/Al mixed oxide. Such a homogeneous Mg/Al mixed oxide exhibits excellent properties for use as a platinum support material in nitrogen oxide storage catalysts in particular when it is coated with a rare earth oxide selected from the group of yttrium oxide, lanthanum oxide, cerium oxide, praseodymium oxide or neodymium oxide or combinations thereof. With regard to the definition of the term “homogeneous mixed oxide”, explanations of the preferred material variants, the technical background and the underlying prior art, reference is made to the application document cited, EP 1 317 953 A1.

When the strongly basic starting support material for platinum present is a homogeneous Mg/Al mixed oxide as described in EP 1 317 953 A1, this gives rise to a preferred catalyst with a reduced desulfurization temperature by virtue of the supporting of half of the platinum on a high-surface area, thermally stable aluminum oxide. In a particularly preferred embodiment, this aluminum oxide has been coated with a rare earth oxide selected from the group consisting of yttrium oxide, lanthanum oxide, cerium oxide, praseodymium oxide or neodymium oxide, or combinations thereof. Aluminum oxide variants covered in this form also generally exhibit even lower basicities than the homogeneous MG/Al mixed oxides since the amphoteric character of the aluminum oxide is dominant. For example, a typical Mg/Al mixed oxide in suspension in water exhibits a resulting pH between 9 and 10, whereas aluminum oxide coated with from 10 to 20% by weight of rare earth oxide based on the total weight, on suspension in water, has a resulting pH of from 7 to 8.

The nitrogen oxide storage components used for the inventive catalyst may be oxides, carbonates or hydroxides of magnesium, calcium, strontium, barium, the alkali metals, the rare earth metals or mixtures thereof. Suitable support materials for these components are thermally stable metal oxides whose melting point is above the temperatures which occur in the process. These metal oxides are preferably selected from the group consisting of cerium oxide, mixed oxides of cerium, aluminum oxide, magnesium oxide, a homogeneous Mg/Al mixed oxide comprising from 5 to 28% by weight of magnesium oxide based on the total weight of the Mg/Al mixed oxide, calcium titanate, strontium titanate, barium titanate, barium aluminate, barium zirconate, yttrium oxide, lanthanum oxide, praseodymium oxide, samarium oxide, neodymium oxide and lanthanum manganate or mixtures thereof.

It is particularly advantageous to use strontium or barium as the nitrogen oxide storage components, which are fixed on a support material composed of cerium oxide or mixed oxides of cerium. A very suitable support material for the nitrogen oxide storage components is a mixed oxide of cerium, especially a cerium/zirconium mixed oxide with a zirconium oxide content of from 1 to 25% by weight, based on the total weight of the mixed oxide. The mixed oxide may additionally be doped with from 0.5 to 90% by weight of at least one oxide of an element from the group formed by zirconium, silicon, scandium, yttrium, lanthanum and the rare earth metals or mixtures thereof, based on the total weight of the storage material. Preference is given to doping the cerium/zirconium mixed oxide with from 0.5 to 10% by weight of lanthanum oxide and/or praseodymium oxide, based on the total weight of cerium/zirconium mixed oxide and lanthanum oxide and/or praseodymium oxide.

In addition to platinum, the inventive nitrogen oxide storage catalyst may comprise a further noble metal selected from the group of ruthenium, rhodium, palladium, iridium, gold or combinations thereof. A particularly good nitrogen oxide storage efficiency can be achieved when palladium or rhodium in addition to platinum have been applied to the homogeneous Mg/Al mixed oxide and/or to the aluminum oxide, since the mutual alloying of the noble metals can lead to a stabilization of the dispersion to thermal sintering.

In order to achieve very substantially complete reduction of the desorbed nitrogen oxides during the NOₓ regeneration phase, it is additionally advantageous to add to the catalyst a further support material on which rhodium or palladium has been deposited. Here too, particularly active, optionally stabilized aluminum oxide is suitable.

The nitrogen oxide storage catalyst formulated by application of the process described has, in its preferred embodiments, been applied on an inert support body composed of ceramic or metal. Very suitable support bodies for automobile applications are flow honeycombs composed of ceramic or metal. Especially for use in diesel vehicles, the use of wall flow filters composed of cordierite or silicon carbide is also possible.

The invention is illustrated in detail hereinafter with reference to some examples and figures. The figures show:

FIG. 1: Intercalation of sulfur oxides during the lean phase in a conventional, barium-based nitrogen oxide storage catalyst

FIG. 2: Intercalation of sulfur oxides during the lean phase in an inventive barium-based nitrogen oxide storage catalyst

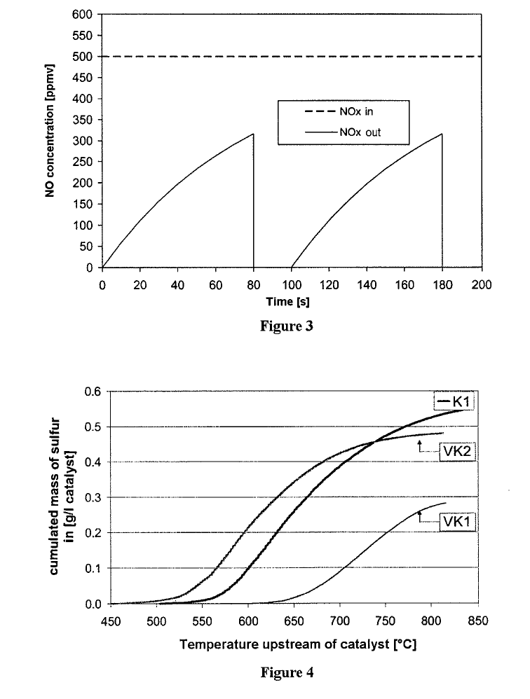

FIG. 3: Determination of the NOₓ storage efficiency

FIG. 4: Cumulated total sulfur output from the inventive catalysts C1 and the comparative catalysts CC1 and CC2 after loading with 1 g of sulfur per liter of catalyst volume

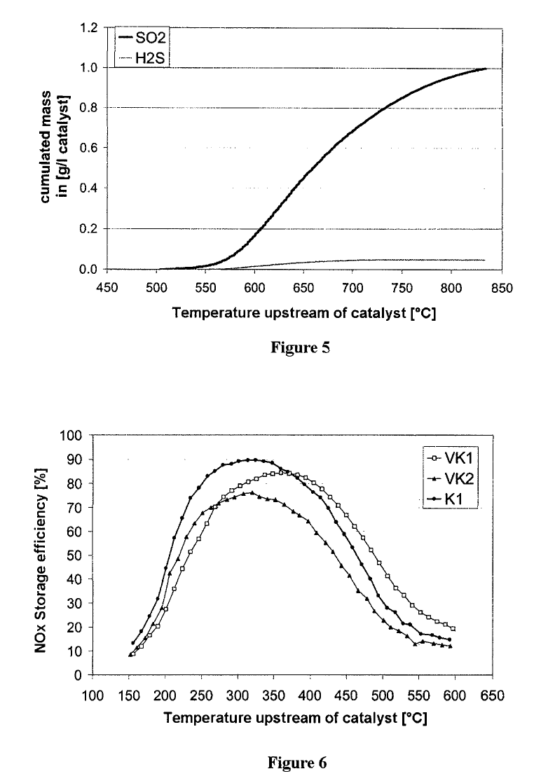

FIG. 5: Proportion of SO₂ and H₂S in the sulfur output from the inventive catalysts C1 after loading with 1 g of sulfur per liter of catalyst volume

FIG. 6: NOₓ storage efficiency of the inventive catalyst C1 and of the comparative catalysts CC1 and CC2 after hydrothermal aging at 750° C. over a duration of 16 h

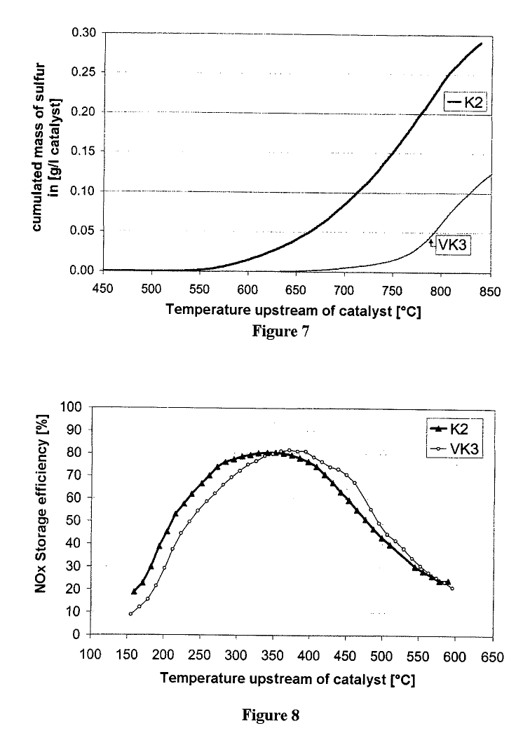

FIG. 7: Cumulated total sulfur output from the catalyst C2 prepared by applying the process according to the invention and the comparative catalyst CC3 after loading with 1 g of sulfur per liter of catalyst volume

FIG. 8: NOₓ storage efficiency of the catalyst C2 prepared by applying the process according to the invention and of the comparative catalyst CC3 after synthetic aging at 750° C. over the duration of 24 h under air

### DETERMINATION OF THE STORAGE EFFICIENCY

In the examples and comparative examples which follow, catalysts were prepared and their storage efficiency for the nitrogen oxides was determined as a function of the exhaust gas temperature. Since the focus of these studies was on the determination of the thermal aging stability of the catalysts produced, the catalysts were subjected to synthetic aging before the analysis. For the inventive catalyst C1 and the comparative catalysts CC1 and CC2, hydrothermal aging conditions were selected. They were exposed to an atmosphere consisting of 10% by volume of oxygen and 10% by volume of water vapor in nitrogen at 750° C. for the duration of 16 hours. In contrast, the inventive catalyst C2 and the comparative catalyst CC3 were stored in air at 750° C. for the duration of 24 hours.

The storage efficiency of a catalyst is the most important parameter for assessing its performance. It describes the efficiency with regard to the removal of nitrogen oxides from the exhaust gas of lean-burn engines.

The NOₓ storage efficiency of the catalysts was determined on a model gas system. To this end, the storage catalysts were exposed to a so-called rich/lean cycle, i.e. lean and rich exhaust gas flowed through the catalysts in alternation. Lean exhaust gas compositions were established by supplying oxygen while simultaneously interrupting the feed of carbon monoxide and hydrogen. Rich exhaust gas compositions were obtained by the reverse procedure.

Within the lean phase, the nitrogen oxides were stored by the particular catalyst. During the rich phases, the nitrogen oxides were desorbed again and converted over the catalyst with the reductive carbon monoxide, hydrogen and hydrocarbon components of the model exhaust gas to nitrogen, carbon dioxide and water.

FIG. 3 shows these conditions in an idealized manner. During the measurements, the exhaust gas had a constant concentration of 500 ppmv (ppm by volume) of nitrogen monoxide (NO). The nitrogen oxide concentration entering the storage catalyst (NOx in) is therefore represented by the broken straight line in FIG. 3. The nitrogen oxide concentration downstream of the storage catalyst (NOx out) is at first zero, since the fresh storage catalyst ideally binds all nitrogen oxides present in the exhaust gas. With increasing time, the storage catalyst becomes laden with nitrogen oxides and its storage capacity decreases. As a result, an increasingly low level of nitrogen oxides is bound on the storage catalyst, and so a rising nitrogen oxide concentration becomes measurable downstream of the catalyst, which would approximate to the starting concentration after complete saturation of the storage catalyst with nitrogen oxides. Therefore, after a certain time (after 80 seconds in FIG. 3), the regeneration of the storage catalyst must be initiated. This is done by enriching the exhaust gas for the duration of about 10 seconds. As a result, the nitrogen oxides stored are desorbed and ideally converted fully over the storage catalyst, such that no nitrogen oxides are measurable downstream of the storage catalyst during the regeneration time. Thereafter, the gas is switched back to lean exhaust gas and the storage of nitrogen oxides begins anew.

The instantaneous storage efficiency of the storage catalyst is defined as the ratio

$$\frac{{NO}_{x} In - {NO}_{x} Out}{{NO}_{x} In} .$$

As is evident from FIG. 3, this efficiency is time-dependent. To assess the storage catalyst, the storage efficiency S integrated over the particular storage phase was therefore determined:

$$S = {\int }_{t = 0}^{80} \frac{{NO}_{x} In - {NO}_{x} Out}{{NO}_{x} In} d t \times 100 [ \% ] .$$

The storage efficiency S is thus not a material constant but depends on the parameters of the rich/lean cycle selected.

For the determination of the nitrogen oxide storage efficiency as a function of the temperature, the catalysts were first heated to 600° C. under the model exhaust gas conditions. Thereafter, the exhaust gas temperature, during the passage through the rich/lean cycles, was lowered continuously by 7°/min in a temperature ramp from 600° C. to 150° C. The nitrogen oxide storage efficiency for one measurement point was determined for each rich/lean cycle and assigned to the mean temperature of the ramp section which was passed through within this period.

The tables below summarize the test conditions for the determination of the storage efficiency.

TABLE 1
Exhaust gas composition

Concentration

| Gas component | during the lean phase | during the rich phase |
|---|---|---|
| CO | 0.0% by vol. | 4% by vol. |
| H₂ | 0.0% by vol. | 1.3% by vol. |
| O₂ | 8.0% by vol. | 0% by vol. |

| | |
|---|---|
| C₃H₈ | 17 ppmv |
| C₃H₆ | 33 ppmv |
| NO | 500 ppmv |
| CO₂ | 10.0% by vol. |
| H₂O | 10.0% by vol. |
| N₂ | remainder |

TABLE 2
Process parameters of the rich/lean cycle

| Parameter | during the lean phase | during the rich phase |
|---|---|---|
| GHSV | 50000 h⁻¹ | |
| T | 600-150° C. in a continuous temperature ramp of 7°/min | |
| λ | 1.5 | 0.88 |
| Duration | 80 s | 10 s |

In FIGS. 6 and 8, the storage efficiencies determined in this way are plotted as a function of the exhaust gas temperature for the nitrogen oxide storage catalysts from the comparative examples described below and the examples.

### Studies of Desulfurization Performance

In addition to the storage efficiency for nitrogen oxides, the desulfurization performance of the catalysts described in the examples and comparative examples which follow was studied in a model gas system. To this end, the catalyst to be tested in each case was treated at 300° C. in a model gas which had the composition specified in table 1 plus 100 ppm of SO₂ and a volume flow of 50 000 l/h. This sulfurization was ended by closing the SO₂ supply as soon as the amount of sulfur passed over the catalyst was 1 gram per liter of catalyst volume, calculated as sulfur. The catalyst was heated to 800° C. in a model gas with the composition described in table 1 at a heating rate of 7.5° C./min in rich/lean cycles, with a rich phase length of 15 seconds and a lean phase length of 5 seconds. During the heating phase, the hydrogen sulfide content and the sulfur dioxide content of the gas downstream of the catalyst were determined with a suitable analytical system. These values were used to calculate the proportion of the desorbed sulfur-containing components and the total amount of sulfur discharged as the cumulated mass of sulfur based on the catalyst volume. Formation of COS in a significant amount was not observed for any of the catalysts studied.

### Comparative Example 1

A nitrogen oxide storage catalyst CC1 according to the prior art was produced according to EP 1 317 953 A1. To this end, an Mg/Al mixed oxide was first doped with cerium oxide by impregnating with cerium nitrate and then calcining. In the resulting support material, the oxidic components were present in the following weight ratio relative to one another:

Al₂O₃:MgO:CeO₂=72:18:10

The finished material had a BET surface area of 105 m²/g. A pH of 9.6 was found in suspensions of the material in water.

114 g of this material were impregnated with an aqueous solution of a water-soluble, chloride-free platinum precursor, dried and calcined at 500° C. under air, such that the finished powder contained 3.5 g of platinum.

To produce a nitrogen oxide storage material, 125 g of a stabilized cerium-zirconium mixed oxide containing 86% by weight of cerium oxide were impregnated with barium acetate and then calcined at 500° C. for the duration of 2 h. The finished storage material contained 25 g of barium, calculated as the oxide.

The two finished powders were suspended in water, ground and applied by means of dipping methods to a commercial honeycomb composed of cordierite with 62 cells per square centimeter and a volume of 1 l. The honeycomb coated in this way was dried at 120° C. in a drying cabinet. This was followed by calcination of the coated honeycomb at 500° C. for two hours.

### Example 1

To produce the inventive catalyst C1, a platinum component which contained 1.75 g of platinum for 90 g/l of the Mg/Al mixed oxide was prepared in the manner described in comparative example 1.

To prepare the less basic platinum component, the support material used was a high-porosity aluminum oxide which had been stabilized with 3% by weight of lanthanum oxide and had a BET surface area of 100 m²/g, the suspension of which in water led to a pH of 7.6. 34 g of this material were impregnated with an aqueous solution of a water-soluble, chloride-free platinum precursor, dried and calcined under air at 500° C., such that the finished powder contained 1.75 g of platinum.

A storage material was produced as described in comparative example 1.

This material was suspended in water together with the two platinum components and 40 g of an uncoated stabilized cerium-zirconium mixed oxide containing 86% by weight of cerium oxide, ground and applied by means of dipping methods to a commercial honeycomb composed of cordierite with 62 cells per square centimeter and a volume of 1 l. The honeycomb coated in this way was dried at 120° C. in a drying cabinet. This was followed by calcination of the coated honeycomb at 500° C. for two hours.

### Comparative Example 2

According to the procedure described in comparative example 1, a further comparative catalyst CC2 was produced, which, in the platinum component, instead of the Mg/Al mixed oxide, contained the less basic, high-porosity aluminum oxide from inventive example 1.

The platinum component which contains 3.5 g of platinum and was prepared in this way was suspended in water together with the storage material described in comparative example 1 and example 1, and 70 g of an uncoated stabilized cerium-zirconium mixed oxide containing 86% by weight of cerium oxide, ground and applied by means of dipping methods to a commercial honeycomb composed of cordierite with 62 cells per square centimeter and a volume of 1 l. The honeycomb coated in this way was dried at 120° C. in a drying cabinet. This was followed by calcination of the coated honeycomb at 500° C. for two hours.

Inventive catalyst 1 and comparative catalysts CC1 and CC2 were laden with 1 gram of sulfur per liter of catalyst volume by the procedure already described in a lean gas atmosphere. Subsequently, they were heated to more than 800° C. under rich/lean cycles. The desorbed sulfur-containing exhaust gas components were detected downstream of the catalyst with a suitable analytical system.

FIG. 4 shows the observed cumulated sulfur output of the three catalysts as a function of temperature. For the catalyst CC1 produced according to EP 1 317 953 A1, which contains only the strongly basic platinum component, the sulfur output does not begin until above 600° C. The desulfurization process selected here with a maximum temperature of 800° C. cannot fully desorb and discharge the sulfur taken up by the catalyst in the preceding lean phase. In contrast, the sulfur output begins actually below 500° C. in the case of comparative catalyst CC2, which contains only the less basic platinum component, and continues over the entire temperature range studied. Over the test time, a cumulated sulfur output significantly higher than that for CC1 is achieved. In the case of the inventive catalyst C1, the sulfur output begins only at slightly higher temperatures of 550° C. than in the case of comparative catalyst CC2. Compared to catalyst CC1 produced according to the prior art, the desulfurization temperature, however, has been lowered by a good 100°. In addition, the curve profile and the amount of sulfur output achieved at the end of the test show that the sulfur has not been as firmly bonded within this catalyst as in the two other catalysts, and the catalyst can accordingly be desulfurized the most completely at comparatively low temperatures.

FIG. 5 shows the proportion of sulfur dioxide and hydrogen sulfide which is released during the desulfurization procedure. The proportion of the malodorous and toxic hydrogen sulfide gas is very low over the entire temperature range. The desorbing sulfur is emitted predominantly as SO₂. This satisfies the requirements of the application.

In order to ensure that the inventive modifications undertaken to lower the desulfurization temperature do not adversely affect the nitrogen oxide storage capacity, catalysts C1, CC1 and CC2 were subjected to a synthetic hydrothermal aging process. To this end, the catalysts were exposed to an atmosphere consisting of 10% by volume of oxygen and 10% by volume of water vapor in nitrogen at a temperature of 750° C. for the duration of 16 h. The result of the subsequent determination of the nitrogen oxide storage capacity is shown in FIG. 6.

A comparison of the nitrogen oxide storage efficiencies of CC1 (□) CC2 (▴) shows that the complete exchange of the strongly basic support oxide of the platinum component from CC1 for the less basic aluminum oxide in CC2 leads to a significant loss of nitrogen oxide storage efficiency after aging. This means a loss of aging stability. The inventive catalyst C1, in contrast, exhibits very good nitrogen oxide storage action () after hydrothermal aging. Especially within the low-temperature range up to 300° C., which is of particular significance for application in the underbody area of diesel vehicles, the improvement in the desulfurization performance shown in FIGS. 4 and 5, compared to CC1, is accompanied by a significant rise in the nitrogen oxide storage efficiency after aging.

In order to show that the process employed for lowering the desulfurization temperature functions irrespectively of the storage material, a further comparative catalyst and a further inventive catalyst with a different nitrogen oxide storage material were produced.

### Comparative Example 3

To produce a nitrogen oxide storage material, 125 g of aluminum oxide stabilized with 3% by weight of lanthanum oxide were impregnated with barium acetate and then calcined at 500° C. for the duration of 2 hours. The finished storage material contained 25 g of barium, calculated as the oxide.

Using this storage material, a comparative catalyst CC3 was produced, which corresponded to CC1 in all other aspects.

### Example 2

The inventive catalyst C2 was produced correspondingly to the catalyst C1 described in example 1, except that the storage material was replaced by the storage material used in comparative example 3.

Both catalysts were first laden in the freshly prepared state with 1 g of sulfur per liter of catalyst volume at 300° C. in a lean gas atmosphere by the method already described, and then desulfurized by heating to 800° C. in rich/lean cycles in which the rich atmosphere was maintained over the duration of 15 seconds, while the lean phase had a length of 5 seconds. FIG. 7 shows the total amount of sulfur discharged for the catalyst C2 formed by application of the process according to the invention, and the corresponding comparative catalyst CC3 corresponding to the prior art to date, as a function of temperature.

In this case too, the employment of the process according to the invention lowered the desulfurization temperature, which is above 650° C. for comparative catalyst CC3, by a good 100° C. to 550° C. (C2).

FIG. 8 also shows the nitrogen oxide storage efficiencies of catalysts C2 (▴) and CC3 (∘) after synthetic aging under air at 750° C. over the duration of 24 hours. The maximum nitrogen oxide storage efficiencies of the two catalysts in the temperature range from 340 to 380° C. are 80.5% (C2) and 81.5% (CC3). The improvement in the nitrogen oxide storage efficiency in the low-temperature range up to 350° C., which is observed for C2 and has particular relevance for the target application of the catalysts in diesel vehicles, as described, is attributable to the addition of uncoated stabilized cerium-zirconium mixed oxide (cf. also C1 from example 1).

It has thus been demonstrated that the process according to the invention for lowering the desulfurization temperature of a nitrogen oxide storage catalyst comprising a platinum component and at least one nitrogen oxide storage material works by lowering the basicity of the chemical environment of the platinum irrespective of the nitrogen oxide storage material used.

1. A process for producing a nitrogen oxide storage catalyst with reduced desulfurization temperature, comprising:
proceeding from a formulation of a prior art nitrogen oxide storage catalyst comprising an amount of platinum component consisting of platinum on a high-surface area, high-melting oxidic support material A
and at least one nitrogen oxide storage material comprising at least one nitrogen oxide storage component on one or more high-melting oxidic support materials,
lowering the basicity of the chemical environment of the platinum compound by applying at least one third of the amount of platinum used to a high-melting, high-surface area oxidic support material B, support material B being less basic than support material A.

2. The process as claimed in claim 1, wherein
half of the amount of platinum used is applied to support material B.

3. The process as claimed in claim 1, wherein
the weight ratio of support material A to support material B is in the range from 1.5:1 to 5:1.

4. The process as claimed in claim 1, wherein
at least 5% by weight of cerium oxide or cerium-zirconium mixed oxide or cerium oxide doped with rare earths or combinations thereof, based on the total amount of the catalytically active components, is added to the nitrogen oxide storage catalyst.

5. A nitrogen oxide storage catalyst with reduced desulfurization temperature, comprising
platinum components consisting of platinum on high-surface area, high-melting oxidic support materials, and
at least one nitrogen oxide storage material comprising at least one nitrogen oxide storage component on one or more high-melting oxidic support materials, wherein:
a first half of the platinum component has been applied to a strongly basic support material and a second half of the platinum component to a less basic support material,
and the nitrogen oxide storage catalyst additionally contains at least 5% by weight of cerium oxide or cerium-zirconium mixed oxide or cerium oxide doped with rare earths or combinations thereof, based on the total amount of the catalytically active components.

6. The nitrogen oxide storage catalyst as claimed in claim 5, wherein
half of the platinum has been applied to a homogeneous Mg/Al mixed oxide composed of magnesium oxide and aluminum oxide, the magnesium oxide being present in a concentration of from 5 to 28% by weight, based on the total weight of the Mg/Al mixed oxide.

7. The nitrogen oxide storage catalyst as claimed in claim 6, wherein
half of the platinum has been applied to a homogeneous Mg/Al mixed oxide composed of magnesium oxide and aluminum oxide, the magnesium oxide being present in a concentration of 5 to 28% by weight, based on the total weight of the Mg/Al mixed oxide, and the other half of the platinum has been applied to a high-surface area, thermally stable aluminum oxide.

8. The nitrogen oxide storage catalyst as claimed in claim 6, wherein
the homogeneous Mg/Al mixed oxide to which half of the platinum has been applied has been coated with a rare earth oxide selected from the group consisting of yttrium oxide, lanthanum oxide, cerium oxide, praseodymium oxide or neodymium oxide, and mixtures thereof.

9. The nitrogen oxide storage catalyst as claimed in claim 6, wherein
magnesium oxide is present in the homogeneous Mg/Al mixed oxide in a concentration of from 10 to 25% by weight, based on the total weight of the mixed oxide.

10. The nitrogen oxide storage catalyst as claimed in claim 7 wherein
the high-surface area, thermally stable aluminum oxide to which the other half of the platinum has been applied has been coated with a rare earth oxide selected from the group consisting of yttrium oxide, lanthanum oxide, cerium oxide, praseodymium oxide, neodymium oxide, and mixtures thereof.

11. The nitrogen oxide storage catalyst as claimed in claim 5 wherein
the nitrogen oxide storage components are oxides, carbonates or hydrates of elements selected from the group consisting of magnesium, calcium, strontium, barium, the alkali metals, the rare earth metals and mixtures thereof.

12. The nitrogen oxide storage catalyst as claimed in claim 11, wherein
the support material for the nitrogen oxide storage component consists of one or more thermally stable metal oxides.

13. The nitrogen oxide storage catalyst as claimed in claim 12, wherein
the thermally stable high-melting metal oxides used as support material for the nitrogen oxide storage components are selected from the group consisting of cerium oxide, mixed oxides of cerium, aluminum oxide, magnesium oxide, a homogeneous Mg/Al mixed oxide comprising from 5 to 28% by weight of magnesium oxide based on the total weight of the Mg/Al mixed oxide, calcium titanate, strontium titanate, barium titanate, barium aluminate, barium zirconate, yttrium oxide, lanthanum oxide, praseodymium oxide, neodymium oxide, samarium oxide, lanthanum manganate and mixtures thereof.

14. The nitrogen oxide storage catalyst as claimed in claim 13, wherein
the nitrogen oxide storage components are an oxide, carbonate or hydroxide of strontium or barium, which are fixed on a support material composed of cerium oxide or mixed oxides of cerium.

15. The nitrogen oxide storage catalyst as claimed in claim 14, wherein
the support material present for the nitrogen oxide storage component is a mixed oxide of cerium which has been doped with from 0.5 to 90% by weight of at least one oxide of the elements selected from the group consisting of zirconium, silicon, scandium, yttrium, lanthanum, the lanthanides and mixtures thereof, based on the total weight of the storage material.

16. The nitrogen oxide storage catalyst as claimed in claim 15, wherein
the support material used for the nitrogen oxide storage components is a cerium/zirconium mixed oxide with a zirconium oxide content of from 1 to 25% by weight, based on the total weight of the mixed oxide.

17. The nitrogen oxide storage catalyst as claimed in claim 16, wherein
the cerium/zirconium mixed oxide used as the support material for the nitrogen oxide storage component has been doped with from 0.5 to 10% by weight of lanthanum and/or praseodymium oxide, based on the total weight of cerium/zirconium mixed oxide and lanthanum oxide and/or praseodymium oxide.

18. The nitrogen oxide storage catalyst as claimed in claim 5 wherein
the catalyst comprises a further noble metal selected from the group consisting of ruthenium, rhodium, palladium, iridium, gold and mixtures thereof.

19. The nitrogen oxide storage catalyst as claimed in claim 18, wherein
palladium or rhodium in addition to platinum have been applied to the homogeneous Mg/Al mixed oxide.

20. The nitrogen oxide storage catalyst as claimed in claim 18, wherein
palladium or rhodium in addition to platinum have been applied to the aluminum oxide.

21. The nitrogen oxide storage catalyst as claimed in claim 18, wherein
the catalyst comprises, as a further support material, an active, optionally stabilized aluminum oxide on which palladium or rhodium has been deposited.

22. The nitrogen oxide storage catalyst as claimed in claim 5,
applied in the form of a coating on an inert support body composed of ceramic or metal.

23. The nitrogen oxide storage catalyst as claimed in claim 22, wherein
the support body is a flow honeycomb composed of ceramic.

24. The nitrogen oxide storage catalyst as claimed in claim 22, wherein
the support body is a wall flow filter composed of cordierite or silicon carbide.

25. A process for cleaning exhaust gases of internal combustion engines operated predominantly under lean burn conditions comprising passing the exhaust gases in contact with the catalyst according to claim 5.
